(19) United States
(12) Patent Application Publication
(10) Pub. No.: US 2025/0226729 A1
(43) Pub. Date: Jul. 10, 2025

(54) STATOR WITH COOLING SYSTEM FOR AN ELECTRIC MOTOR OF AN ELECTRIC AIRCRAFT

(71) Applicant: BETA AIR LLC, South Burlington, VT (US)

(72) Inventor: Chenjie Lin, Fuquay-Varina, NC (US)

(21) Appl. No.: 19/092,023

(22) Filed: Mar. 27, 2025

Related U.S. Application Data
(62) Division of application No. 17/966,662, filed on Oct. 14, 2022.

(51) Int. Cl. H02K 9/22; B64C 29/00; B64D 27/24; B64D 33/08

(52) U.S. Cl. CPC H02K 9/227; B64D 27/24; B64D 33/08; B64C 29/0025

(57) ABSTRACT

A stator with cooling system for an electric motor of an electric aircraft and a method of manufacturing a stator of an electric motor for an electric aircraft with cooling system are disclosed. The stator may include a winding configured to provide magnetic flux and comprising an electrically conductive material. The stator may further include a soft magnet configured to hold the winding. The stator may further include a passive heat sink in thermal communication with the winding and comprising a phase change material.

### CROSS REFERENCE TO RELATED APPLICATION

This application is a divisional of U.S. application Ser. No. 17/966,662, filed Oct. 14, 2022, the disclosure of which is incorporated herein by reference in its entirety.

### FIELD OF THE INVENTION

The present invention generally relates to the field of electric aircraft. In particular, the present invention is directed to a stator with cooling system for an electric motor of an electric aircraft.

### BACKGROUND

In electric multi-propulsion systems such as electric vertical take-off and landing (eVTOL) aircraft, the propulsors are constrained by volumetric, gravimetric, and thermal concerns. Design and assembly of the propulsor units must be done in a manner which reduces volumetric, gravimetric, and thermal issues to enable efficient flight. Existing approaches to mitigating these issues are limited.

### SUMMARY OF THE DISCLOSURE

In an aspect, the present disclosure is directed to a stator with cooling system for an electric motor of an electric aircraft. The stator may include a winding configured to provide magnetic flux and comprising an electrically conductive material. The stator may further include a soft magnet configured to hold the winding. The stator may further include a passive heat sink (i.e., heatsink) in thermal communication with the winding and comprising a phase change material.

In another aspect, the present disclosure is directed to a method for manufacturing a stator with cooling system of an electric motor for an electric aircraft. The method may include holding, using a work-holding device, a first segment of soft magnet. The method may further include creating, using a winding device, a winding in the first segment of soft magnet, wherein creating the winding further comprises acquiring an electrically conductive material and winding the electrically conductive material upon each soft magnet of the plurality of soft magnet using the electrically conductive material, thereby creating a winding for each soft magnet. The method may further include installing, using an installation device, a plurality of segments of soft magnet into the stator.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A-B is an exemplary embodiment of a portion of a stator assembly used in an electric motor assembly in partial planform view;

FIG. 2 is an embodiment of a stator and of a plurality of windings;

FIG. 3 is an embodiment of a schematic diagram of a plurality of windings;

FIG. 4 is an illustration of an exploded view of an electric motor in a propulsion assembly;

FIG. 5 is an embodiment of an integrated motor incorporated in an electric aircraft; and

FIG. 6 is a flow diagram of a method for manufacturing a stator with cooling system for an electric motor of an electric aircraft.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to assembly of a stator with cooling system in an electric motor of an electric aircraft. In an embodiment, the electric aircraft may be an electric vertical takeoff and landing aircraft.

Aspects of the present disclosure can be used to contain a winding configured to provide magnetic flux and comprising an electrically conductive material.

Aspects of the present disclosure allow for containing a passive heat sink in a stator, wherein the passive heat sink may be in thermal communication with a winding and comprising a phase change material. Exemplary embodiments illustrating aspects of the present disclosure are described below in the context of several specific examples.

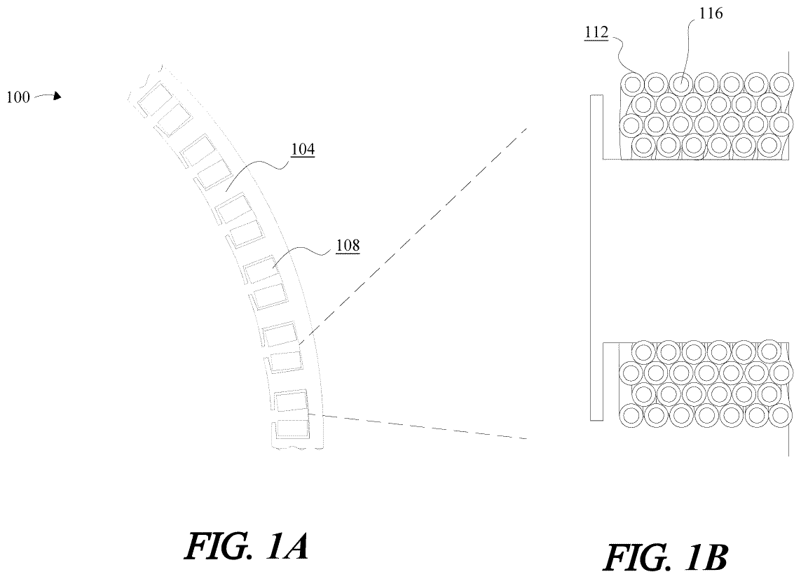

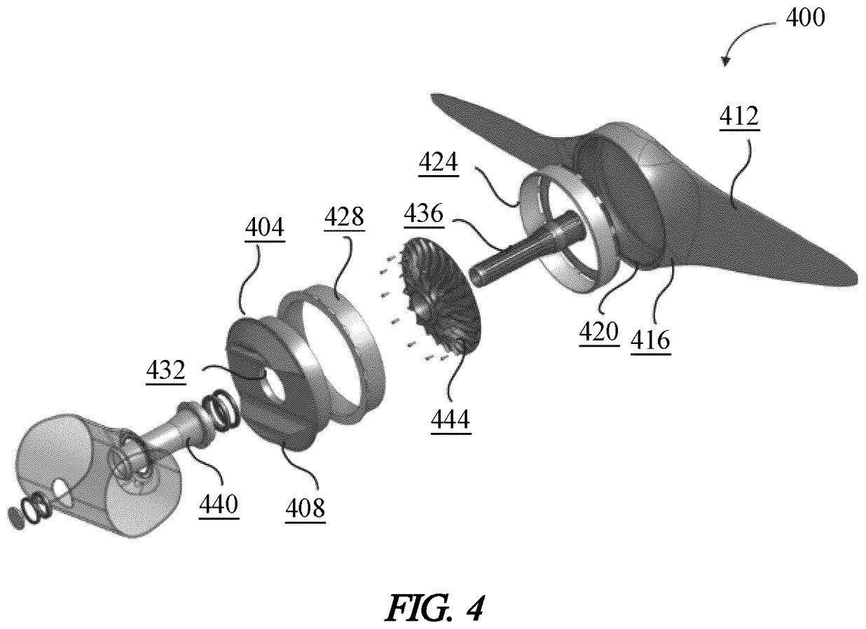

Referring now to FIG. 1A-B, an exemplary embodiment of a portion of a stator 100 used in an electric motor assembly in partial planform view is presented. Stator 100 may include soft magnet 104, winding 108, hollow conductor 112, and channel 116. A “stator,” as used herein, is a stationary component of a motor and/or motor assembly. In an embodiment, stator 100 may include an annular stator, wherein the stator is ring-shaped. In an embodiment, stator 100 may be incorporated into a DC motor where stator 100 is fixed and functions to supply the magnetic fields where a corresponding rotor rotates. In an embodiment, stator 100 may be incorporated into an AC motor where stator 100 is fixed and functions to supply the magnetic fields by radio frequency electric currents through an electromagnet to a corresponding rotor rotates. As used herein, a “rotor” is a portion of an electric motor that rotates with respect to stator 100 of an electric motor. The rotor is further described in FIG. 4. Stator 100 disclosed herein may be consistent with a stator in U.S. patent application Ser. No. 17/144,304 entitled “METHODS AND SYSTEMS FOR A FRACTIONAL CONCENTRATED STATOR CONFIGURED FOR USE IN ELECTRIC AIRCRAFT MOTOR,” and in U.S. patent application Ser. No. 17/892,816 entitled “METHODS AND APPARATUS FOR MANUFACTURING A STATOR FOR AN ELECTRIC AIRCRAFT MOTOR,” which are incorporated in their entirety herein by reference.

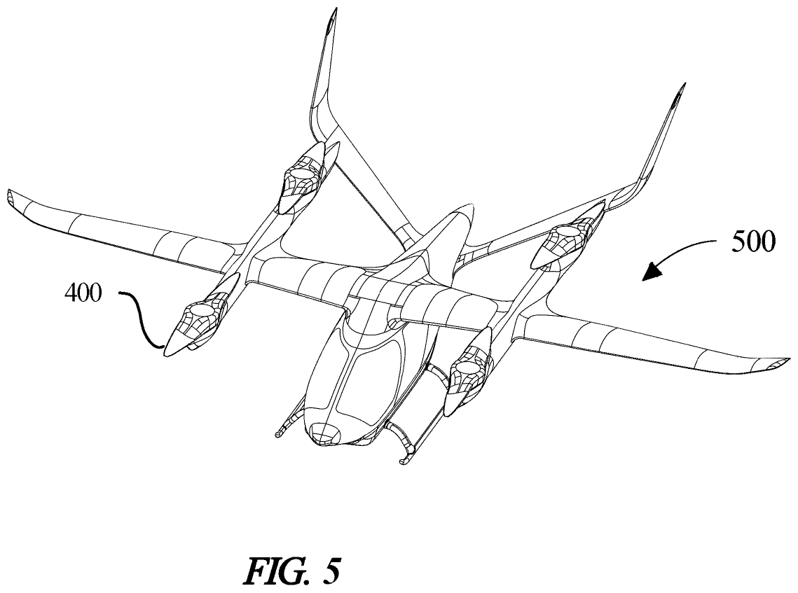

At least a portion of stator 100 may be mechanically coupled to at least a portion of an electric aircraft, for instance and without limitation as described below with reference to FIG. 5. As used herein, a person of ordinary skill in the art would understand “mechanically coupled” to mean that at least a portion of a device, component, or circuit is connected to at least a portion of the electric aircraft via a mechanical coupling. Said mechanical coupling may include, as a non-limiting example, rigid coupling, such as beam coupling, bellows coupling, bushed pin coupling, constant velocity, split-muff coupling, diaphragm coupling, disc coupling, donut coupling, elastic coupling, flexible coupling, fluid coupling, gear coupling, grid coupling, hirth joints, hydrodynamic coupling, jaw coupling, magnetic coupling, Oldham coupling, sleeve coupling, tapered shaft lock, twin spring coupling, rag joint coupling, universal joints, or any combination thereof. In an embodiment, mechanical coupling can be used to connect the ends of adjacent parts and/or objects of an electric aircraft. Further, in an embodiment, mechanical coupling may be used to join two pieces of rotating electric aircraft components.

With continued reference to FIG. 1A-B, in some embodiments, stator 100 may include soft magnet 104, wherein soft magnet 104 may be configured to hold winding 108. Winding 108 herein is disclosed further in detail below. Soft magnet 104 may have low coercivity, meaning that it can be easily magnetized and demagnetized. Soft magnet 104 may enhance and/or channel a magnetic flux produced by an electric current. As a non-limited example, soft magnet 104 may be an annealed iron that can be magnetized but do not tend to stay magnetized. Soft magnet 104 may have high relative permeability, which is a measure of how readily the material responds to the applied magnetic field. In direct current (DC) applications, soft magnet 104 may be magnetized in order to perform an operation and then demagnetized at the conclusion of the operation. In alternating current (AC) applications, soft magnet 104 may be continuously cycled from being magnetized in one direction to the other, throughout the period of operation (e.g. a power supply transformer). In AC applications, how much energy is lost in the system as soft magnet 104 is cycled around its hysteresis loop may be considered. The energy loss may originate from hysteresis loss, wherein the hysteresis loss is related to the area contained within the hysteresis loop. Hysteresis losses may be reduced by the reduction of the intrinsic coercivity with a consequent reduction in the area contained within the hysteresis loop. The energy loss may originate from eddy current loss, wherein the eddy current loss is related to the generation of electric currents in the magnetic material and the associated resistive losses. The eddy current losses may be reduced by decreasing the electrical conductivity of the material and by laminating the material, which has an influence on overall conductivity and is important because of skin effects at higher frequency. The energy loss may originate from anomalous loss, wherein the anomalous loss is related to the movement of domain walls within the material. The anomalous losses may be reduced by having a completely homogeneous material, within which there may be no hindrance to the motion of domain walls.

With continued reference to FIG. 1, in some embodiments, stator 100 may include a soft magnet 104. In some embodiments, soft magnet 104 may be attached to an inner surface of stator 100, wherein the inner surface of stator 100 used herein may be a surface of stator 100 close to rotation axis. An “axis of rotation,” as used in this disclosure, is a straight line through all fixed points of a rotating rigid body, such as but not limited to electric motor, around which all other points of the body move in circles. In some embodiments, soft magnet 104 may extend radially inward toward a rotation axis but may not intersect with the rotation axis. Soft magnet 104 may be radially symmetrical about rotation axis, symmetrical about some other axis, or not symmetrical about any cross section. Soft magnet 104 may extend from a first end to a second end of stator. Soft magnet 104 may be a polygonal shape like a rectangle, square, circle, oval, T-shape, or substantially similar shape. Soft magnet 104 may, in some embodiments, be flanged. Soft magnet 104 may be insulated using an insulation material. As used in this disclosure, “insulating” is to separate the conducting bodies with nonconductors to prevent transfer of electricity, and/or heat, and/or sound. The insulation material may include, but is not limited to, fiberglass, mineral wool, cellulose, natural fibers, polystyrene, polyisocyanurate, polyurethane, perlite, cementitious foam, phenolic foam, insulation facings, and the like. In an embodiment, one or more fiberglass sheets may be applied to soft magnet 104.

With continued reference to FIG. 1A-B, in some embodiments, stator 100 may include winding 108. In some embodiments, winding 108 may be configured to provide a path for current to flow to create then a magnetic field to spin a rotor. In some embodiments, winding 108 may wound upon soft magnet 104. In an embodiment, winding 108 may include a first curve, wherein first curve is a first portion of winding 108 wound on a first surface of soft magnet 104. Winding 108 may wound upon soft magnet 104 in one or more layers. In another embodiment, winding 108 may include a second curve, wherein second curve is a second portion of winding 108 wound on a second surface of soft magnet 104. In some embodiments, winding 108 may include an electrically conductive material. The electrically conductive material may include a wire, filament, or other suitable material and configuration thereof to conduct electricity through it. The electrically conductive material may be soft, and/or bendable, and/or malleable, and/or the like. The electrically conductive material may include any material that is conductive to electrical current and may include, as a nonlimiting example, various metals such as copper, steel, or aluminum, carbon conducting materials, or any other suitable conductive material. In some embodiment, the electrically conductive material may include a multi-stranded conducting wire. A “multi-stranded conducting wire,” is a bundle of a plurality of conducting wires. The multi-stranded conducting wire may be more flexible than solid wire of the same total cross-sectional area as the bundle. A “conducting wire,” as used in this disclosure, is an electrically conductive wire that is capable of carrying electricity over a distance. Persons skilled in the art, upon reviewing the entirety of this disclosure, will be aware of various forms of electrically conductive material that may be used as windings on soft magnet consistent with the described methods and systems.

With continued reference to FIG. 1A-B, in some embodiments, the electrically conductive material wound upon soft magnet 104 may include Litz wires. Litz wires are a special type of multistrand wire or cable used in electronics to carry alternating current at radio frequencies. The Litz wire is designed to reduce the skin effect and proximity effect losses in conductors at frequencies up to about 1 Megahertz (MHz). The skin effect of electrical conductors is the tendency of an alternating current to become distributed within a conductor such that the current density is largest near the surface of the conductor and decreases exponentially with greater depths in the conductor. Therefore, the electric current flows mostly at the “skin” of the conductor, or more accurately, the portion of the wire or conductor at the greatest radial distance from the center line or centroid of the conductor. The skin depth, or area of conductor that electric current flows through depends on the frequency of the alternating current. Litz wire can be used to mitigate the skin effect by weaving insulated wires together in a carefully designed pattern such that the magnetic field acts equally on all the wires and causes to the total current to be distributed equally among the wires. The woven insulated wires do not suffer the same increase in alternating current resistance that a solid conductor of the same cross-sectional area would be due to the skin effect. The proximity effect in electrical conductors is the tendency of nearby conductors to distribute current in smaller regions within the present conductors. The crowding of conductors near each other increases the effective resistance due to the smaller area current can flow through in a conductor, and the effective resistance increases with frequency. Litz wires mitigates the loss due to proximity effect by distributing conductive paths in an arrangement that reduces effective electromagnetic fields.

With continued reference to FIG. 1A-B, in some embodiments, the electrically conductive material may include hollow conductor 112. A “hollow conductor,” as used in this disclosure, is a type of a cable conductor which is constructed in a way to provide a central channel. Hollow conductor 112 may have larger diameter compared to solid conductor for same current capacity. A solid conductor is a conductor constructed of single piece of metal. Hollow conductor 112 may reduce the skin effect losses and corona discharge in a conductor. Corona discharge is an electrical discharge caused by the ionization of a fluid such as air surrounding a conductor carrying a high voltage. It represents a local region where the air (or other fluid) has undergone electrical breakdown and become conductive, allowing charge to continuously leak off the conductor into the air. A corona discharge occurs at locations where the strength of the electric field (potential gradient) around a conductor exceeds the dielectric strength of the air. The dielectric strength is the maximum electrical potential that a material can resist before the electrical current breaks through the material. Increasing conductor size may raise the voltage at which corona occurs. In some embodiments, hollow conductor may be hermetically sealed. A “hermetic seal,” as used in this disclosure, is a type of sealing that makes a given object airtight, preventing the passage of gas, liquid, solid, or the like. As a non-limiting example, hermetic seal may include epoxy hermetic seal, metal hermetic seal, glass hermetic seal, plastic hermetic seal, ceramic hermetic seal, and the like. Metal hermetic seal may be done by welding metals together. Glass hermetic seal may be done through matched sealed or compression seal on a metal and a glass. Compression seals my withstand temperatures up to 250 Celsius. Matched seals may withstand temperatures up to 450 Celsius.

With continued reference to FIG. 1A-B, in some embodiments, hollow conductor 112 may include channel 116. A “channel,” as used in this disclosure, is a channel within a hollow conductor. Channel 116 may not be exposed to the magnetic field that stator 100 generates. “Magnetic field,” as used in this disclosure, is a vector field that describes the magnetic influence on moving electric charges, electric currents, and magnetic materials. Channel 116 may be configured to act as a passive heat sink. A “passive heat sink,” as used in this disclosure, is a passive heat exchanger that transfers the heat generated by an electronic or a mechanical device to a fluid medium, often but not limited to air or a liquid coolant, where it is dissipated away from the device, thereby allowing regulation of the device's temperature.

With continued reference to FIG. 1, in some embodiments, channel 116 may be configured to contain coolant media. “Coolant,” as used in this disclosure, is any flowable heat transfer medium. Coolant may include a liquid, a gas, a solid, and/or a fluid. Coolant may include a compressible fluid and/or a non-compressible fluid. Coolant may include a non-electrically conductive liquid such as a fluorocarbon-based fluid, such as without limitation Fluorinert™ from 3 M of Saint Paul, Minnesota, USA. In some cases, coolant may include air. Alternatively or additionally, in some cases, coolant may include a solid (e.g., bulk material) and coolant flow may include motion of the solid. Exemplary forms of mechanical motion for bulk materials include fluidized flow, augers, conveyors, slumping, sliding, rolling, and the like. Additional disclosure related to coolant may be found in U.S. patent application Ser. No. 17/405,840 entitled “CONNECTOR AND METHODS OF USE FOR CHARGING AN ELECTRIC VEHICLE,” which is incorporated in its entirety herein by reference.

With continued reference to FIG. 1, in some embodiments, the coolant media may include a phase change material. A “phase change material (PCM),” as used in this disclosure, is a substance which releases/absorbs sufficient energy at phase transition to provide useful heat or cooling. “Phase transition,” as used in this disclosure, is a physical process of transition between a state of a medium, identified by some parameters, and another one, with different values of the parameters. The phase transition may occur among without limitation solid, liquid, gas, plasma, and the like. A phase change material for an electric motor may be chosen considering various factors: a transition temperature, compatibility with a base, density, latent heat capacity, volume, weight, thermal conductivity, cost, and the like. A “transition temperature,” as used in this disclosure and also known as a phase change temperature and/or a melting point, is a temperature at which a material changes from one state to another. A “thermal conductivity,” as used in this disclosure, is a measure of its ability to a particular material conduct heat. A “latent heat capacity,” as used in this disclosure, is a capacity of a phase change material to absorb or release a heat during a phase transition. The latent heat capacity may vary depending on how much power is being applied to the material and how much the material is used in few seconds to a few hours. Thermophysical properties of different types of phase change materials is shown in table below.

| | Phase | | | | Latent | Vol. | Specific | | | | |
|---|---|---|---|---|---|---|---|---|---|---|---|
| | Change | | Density | Density | heat | heat | heat | | Thermal | Vol. | |
| | Temp | | solid | liquid | capacity | capacity | capacity | Viscosity | Cond. | Expan. | |
| Name | (degC.) | TYPE | (kg/m³) | (kg/m³) | (kJ/kg) | (MJ/m³) | (kJ/kgK) | (mm²/s) | (W/mK) | (%) | Source |
| RT4 | −4 | Organic | 880 | 760 | 179 | 147 | | 17.81 | 0.2 | 16 | Rubitherm |
| RT3 | 4 | Organic | 880 | 770 | 198 | 163 | | 17.57 | 0.2 | 14 | Rubitherm |
| RT60 | 60 | Organic | 880 | 770 | 144 | 119 | | 37.5 | 0.2 | 14 | Rubitherm |
| RT82 | 82 | Organic | 880 | 770 | 176 | 145 | | 45.45 | 0.2 | 14 | Rubitherm |
| RT27 | 27 | Organic | 880 | 760 | 184 | | | 26.32 | 0.2 | 16 | Rubitherm |
| RT50 | 49 | Organic | 880 | 760 | 168 | | | 31.2 | 0.2 | 16 | Rubitherm |
| RT65 | 65 | Organic | 880 | 780 | 152 | | | 38.96 | 0.2 | 12 | Rubitherm |
| SP21E | 21 | Hydrated | | 1500 | 160 | 240 | 2 | | 0.6 | 3 | Rubitherm |
| | | Salt | | | | | | | | | |
| S89 | 89 | Hydrated | | 1550 | 151 | 234 | 2.48 | | 0.68 | | PCM |
| | | Salt | | | | | | | | | products |
| C70 | 70 | Hydrated | | 1400 | 283 | 396 | 3.6 | | 0.5 | | Climator |
| | | salt | | | | | | | | | |
| C58 | 58 | Hydrated | | 1460 | 288 | 421 | 1.8 | | 0.6 | | Climator |
| | | salt | | | | | | | | | |

With continued reference to FIG. 1, in some embodiments, a phase change material may have a mass which is a function of an operation time (T) of an electric motor. As a non-limiting example, a mass of a phase change material may increase as an operation time of an electric motor increases. As another non-limiting example, a mass of a phase change material may decrease as an operation time of an electric motor decreases.

PCM mass∝T

With continued reference to FIG. 1, in some embodiments, a phase change material may have a mass which is a function of a power (P) of an electric motor. As a non-limiting example, a mass of a phase change material may increase as a power of an electric motor increases. As a non-limiting example, a mass of a phase change material may decrease as a power of an electric motor decreases.

PCM mass∝P

As an electric motor transform electrical energy into mechanical work, mechanical power output may be used to measure a power of an electric motor. Two variables may determine the power of an electric motor: angular speed and torque. Angular speed is a measure of how fast a rigid body rotates with respect to its center of rotation, such as not limited to a rotor of an electric motor rotating with respect to an axis of rotation. Torque is a measure of the force that can cause an object to rotate about an axis. The power of an electric motor may be calculated by using the following formula:

$${P}_{m} = {P}_{out} = τ * ω ,$$

wherein Pₘₒₜₒᵣ is power of electric motor, Pₒᵤₜ is output power measured in watts (W), τ is torque measured in Newton-meters (N·m) or foot-pounds (ft/lbs), and ω is angular speed measured in radians per second (rad/s). Angular speed may be calculated with the following formula:

$$ω = rpm * 2 π / 60 ,$$

wherein rpm is rotational speed in revolutions per minute.

With continued reference to FIG. 1, in some embodiments, a phase change material may have a mass which is a function of an efficiency (η) of an electric motor. As a non-limiting example, a mass of a phase change material may decrease as an efficiency of an electric motor increases. As another non-limiting example, a mass of a phase change material may increase as an efficiency of an electric motor decreases.

$$PCM mass ∝ 1 / η$$

The efficiency of an electric motor may be calculated by using the following formula:

$$η = {P}_{m} / {P}_{e} = {P}_{out} / {P}_{in} , {P}_{e} = {P}_{in} = IV ,$$

wherein Pₑ is an input electrical power measured in watts (W), V is an applied voltage measured in volts (V) and I is a current measured in amperes (A). As a non-limiting example, efficiency of an electric motor in electric aircraft may be 52%.

With continued reference to FIG. 1, in some embodiments, a phase change material may have a transition temperature (Tₜ) which is a function of an operation temperature (Tₒₚ) of an electric motor. A “operation temperature,” as used in this disclosure, is an allowable temperature range of the local ambient environment at which an electrical or mechanical device operates. The device will operate effectively within a specified temperature range which varies based on the device function and application context, and ranges from the minimum operating temperature to the maximum operating temperature (or peak operating temperature). Outside this range of safe operating temperatures, the device may fail. As a non-limiting example, a phase material with a high transition temperature may be used as a minimum operation temperature of an electric motor is high. As another non-limiting example, a phase material with low a transition temperature may be used as a minimum operation temperature of an electric motor is low. In an embodiment, a transition temperature of a phase change material may be equal to a minimum operation temperature of an electric motor. In another embodiment, a transition temperature of a phase change material may be below a minimum operation temperature of an electric motor. As a non-limiting example, a transition temperature of a phase change material may be 60° C. As an operation temperature of an electric motor is 60° C. As a non-limiting example, a transition temperature of a phase change material may be 55° C. as an operation temperature of an electric motor is 60° C.

PCM Tₜ∝Tₒₚ

With continued reference to FIG. 1, in some embodiments, channel 116 containing a coolant media may be configured to be in thermal communication with hollow conductor 112, acting as a passive heat sink. “Communication,” as used in this disclosure, is an attribute wherein two or more relata interact with one another, for example within a specific domain or in a certain manner. In some cases, communication between two or more relata may be of a specific domain, such as without limitation electric communication, fluidic communication, informatic communication, mechanic communication, thermal communication and the like. “Thermal communication,” as used in this disclosure, is an attribute wherein two or more relata interact with one another by way of heat flow. In an embodiment, channel 116 may include an insulative layer. The insulation material may include, but is not limited to, fiberglass, mineral wool, cellulose, natural fibers, polystyrene, polyisocyanurate, polyurethane, perlite, cementitious foam, phenolic foam, insulation facings, and the like. In an embodiment, channel 116 containing a coolant media may absorb and store heat energy from an electric motor during a vertical takeoff of an electric vertical takeoff and landing (eVTOL) aircraft. In the vertical takeoff period, the eVTOL aircraft may use a vertical propulsor system. A vertical propulsor is a propulsor that propels the aircraft in an upward direction; one of more vertical propulsors may be mounted on the front, on the wings, at the rear, and/or any suitable location. A vertical propulsor may generate a substantially downward thrust, tending to propel an aircraft in a vertical direction providing thrust for maneuvers such as without limitation, vertical take-off, vertical landing, hovering, and/or rotor-based flight such as “quadcopter” or similar styles of flight. After the vertical takeoff when the eVTOL aircraft is on “airplane”-style flight mode, channel 116 containing a coolant media may dissipate the heat energy. The eVTOL aircraft may use a forward propulsor system to perform “airplane”-style flight. A forward propulsor as used in this disclosure is a propulsor positioned for propelling an aircraft in a “forward” direction; at least a forward propulsor may include one or more propulsors mounted on the front, on the wings, at the rear, or a combination of any such positions. Forward in this context is not an indication of the propulsor position on the aircraft; one or more propulsors mounted on the front, on the wings, at the rear, etc. A forward propulsor may propel an aircraft forward for fixed-wing and/or “airplane”-style flight, takeoff, and/or landing, and/or may propel the aircraft forward or backward on the ground. In another embodiment, channel 116 containing a coolant media may store heat energy during a vertical landing of an eVTOL aircraft. After the vertical landing when the eVTOL aircraft is on the ground, channel 116 containing a coolant media may dissipate the heat energy.

With continued reference to FIG. 1A-B, stator 100 may include inverter electronically connected to an electric motor. In some embodiments, the inverter may be a component of an electric motor. In some embodiments, the inverter may be configured to accept a direct current and produce an alternating current. An “inverter,” as used in this this disclosure, is a power electronic device or circuitry that changes direct current (DC) to alternating current (AC). An inverter (also called a power inverter) may be entirely electronic or may include at least a mechanism (such as a rotary apparatus) and electronic circuitry. In some embodiments, static inverters may not use moving parts in conversion process. Inverters may not produce any power itself; rather, inverters may convert power produced by a DC power source. Inverters may often be used in electrical power applications where high currents and voltages are present; circuits that perform a similar function, as inverters, for electronic signals, having relatively low currents and potentials, may be referred to as oscillators. In some cases, circuits that perform opposite function to an inverter, converting AC to DC, may be referred to as rectifiers. Further description related to inverters and their use with electrical motors used on electric VTOL aircraft is disclosed within U.S. patent application Ser. No. 17/144,304 entitled “METHODS AND SYSTEMS FOR A FRACTIONAL CONCENTRATED STATOR CONFIGURED FOR USE IN ELECTRIC AIRCRAFT MOTOR” filed on Jan. 8, 2021 and by C. Lin et al. Additional descriptions related to inverters and electrical motors are disclosed in U.S. patent application Ser. No. 17/197,427 entitled “SYSTEM AND METHOD FOR FLIGHT CONTROL IN ELECTRIC AIRCRAFT” by T. Richter et al. and filed on Mar. 10, 2021.

With continued reference to FIG. 1A-B, in some embodiments, an inverter may be configured to accept direct current and produce alternating current. As used in this disclosure, “alternating current” is a flow of electric charge that periodically reverses direction. In some cases, an alternating current may continuously change magnitude overtime; this is in contrast to what may be called a pulsed direct current. Alternatively or additionally, in some cases an alternating current may not continuously vary with time, but instead exhibit a less smooth temporal form. For example, exemplary non-limiting AC waveforms may include a square wave, a triangular wave (i.e., sawtooth), a modifier sine wave, a pulsed sine wave, a pulse width modulated wave, and/or a sine wave. As a further non-limiting example, inverter may include receiving a first input voltage and outputting a second voltage, wherein the second voltage is different from the first voltage.

With continued reference to FIG. 1A-B, in some embodiments, inverter may draw direct current from a power source. As used in this disclosure a “power source” is a source that that drives and/or controls any other flight component. For example, and without limitation power source may include an inverter that powers an electric motor that operates to move one or more lift propulsor components, to drive one or more blades, or the like thereof. An electric motor may be driven by direct current (DC) electric power from an inverter and may include, without limitation, brushless DC electric motors, switched reluctance motors, induction motors, or any combination thereof. An electric motor may also include electronic speed controllers or other components for regulating motor speed, rotation direction, and/or dynamic braking.

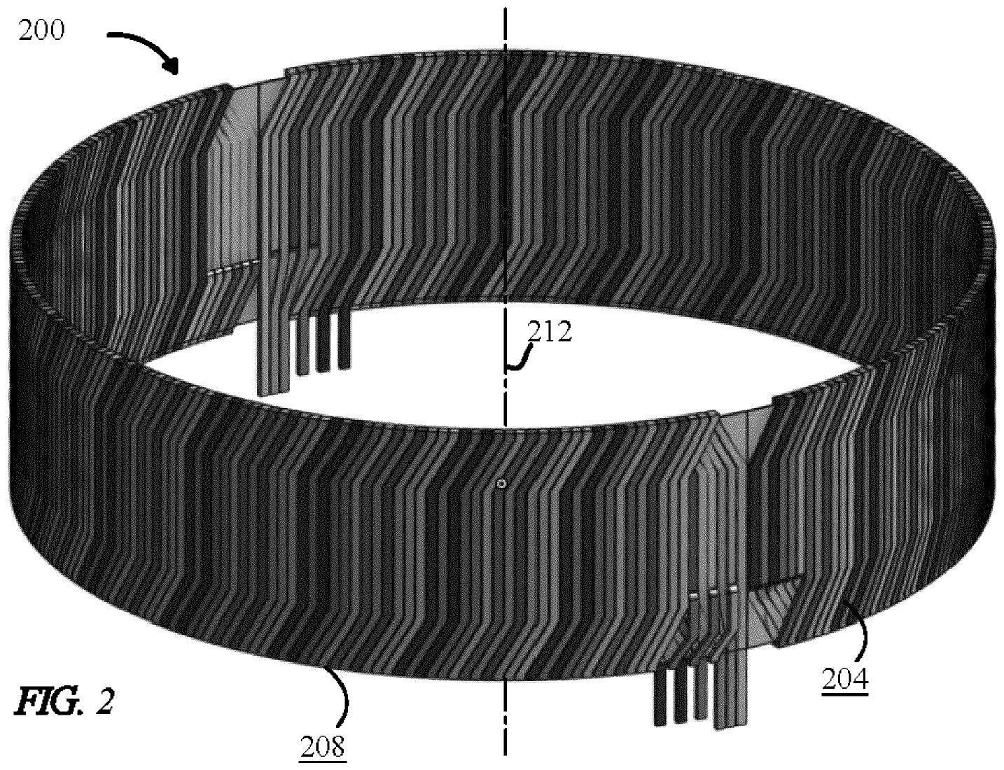

Referring now to FIG. 2, an embodiment of windings 200 is presented, which may be used in the stator 100 is presented. Windings 200 may include axis of rotation 212. Axis of rotation 212 is the common center of the plurality of radially symmetric elements presented in the disclosure. For example, axis of rotation 212 is virtually equidistant to every point on inner cylindrical surface of the stator 100 and virtually equidistant to every point on outer cylindrical surface of the stator 100. Axis of rotation 212 is coincident with the centerline hereinabove disclosed.

With continued reference to FIG. 2, windings 200 may include first winding 204 or second winding 208. With continued reference to FIG. 2, modular winding sets 120, which include electrically conductive wires, may be wound upon the plurality of teeth of the stator 100 in a single layer. Modular winding set 120 may be wound upon the plurality of teeth of the stator 100 in a double layer. For the purposes of this disclosure, layers refer to a winding of at least a segment of electrically conductive material laying on the surface of the plurality of teeth. A single layer lays directly on and around a plurality of teeth of the stator 100, while the second layer (i.e. the double layer configuration) would lay on the single layer below it. One of ordinary skill in the art would understand a single layer of wound electrically conductive wire may effectively transmit electrical energy through said winding and produce a magnetic field. In an illustrative embodiment, a double layered electrical wire winding may include a cross-sectional arrangement that a second layer may lay in the groove created by two adjacent windings in a first single layer below it relative to the plurality of teeth. In another illustrative embodiment, a double layer may be disposed on a segment in the layer directly below it relative the plurality of teeth.

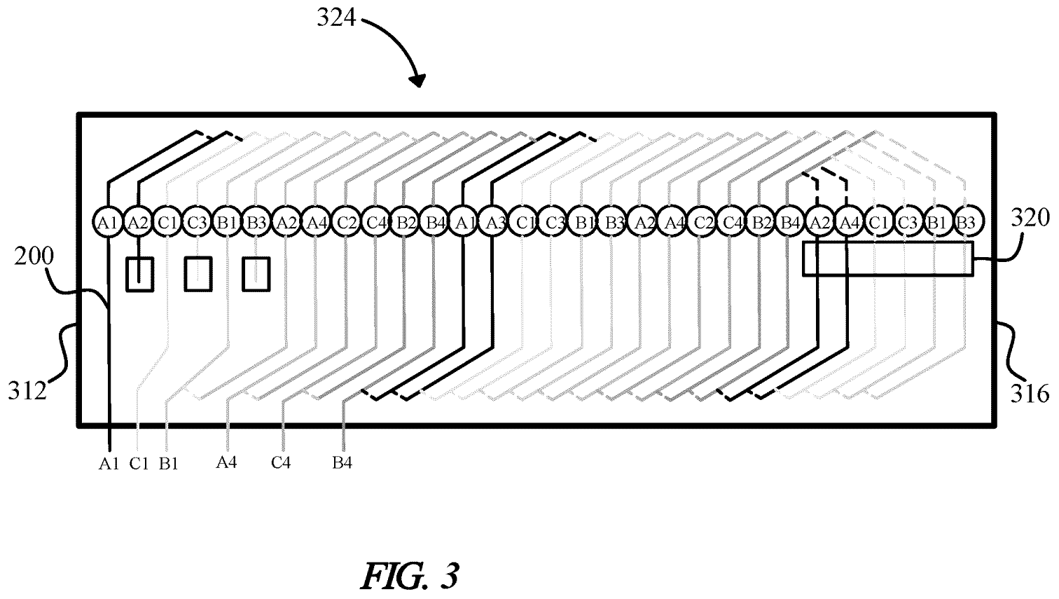

Referring now to FIG. 3, a schematic diagram illustrates a portion of windings 200 on a stator half; a portion of windings 200 may be suitable for use as first winding 204 and/or second winding 208. First winding 204 may include a first phase (initially denoted A1) that may traverse a first set of channels from first end 312, to second end 316, passing through mandrel through-hole 320 at second end 316 (with first phase now denoted as A2). A2 now traverses a second set of channels back to the first end 312. A first phase may additionally pass through second mandrel through-hole 320 at first end 312 (after which first phase is denoted as A3 in FIG. 3), and traverse a third set of channels to second end 316, and may pass through third mandrel through-hole 320 at second end 316 (now denoted as A4), and traverses a fourth set of channels back to first end 312. First winding 204 may include at least a second phase electrically isolated from the first phase; as illustrated without limitation in FIG. 3 there may be three total phases (A1-4, B1-4, and C1-4). Alternatively, or additionally, there may be more than three total phases of windings, or less than three phases. First winding 204 may be connected to at least a first inverter to provide current to the winding. In nonlimiting illustrative embodiments, each half of mandrel 324 may have 3 phases, corresponding to a total of 3 windings, and therefore there may be 3 inverters connected to 3 windings. A second winding may include a second phase that traverses a fifth set of channels from a fourth end to a fourth through-hole at the third end, and then traverses a sixth set of channels back to the fourth end, as described in first winding 204 in FIG. 2. A third winding may include a third phase that traverses a fifth through hole at a fourth end, and may traverse a seventh set of channels to a second end, and may pass through a sixth through-hole at a third end, and traverse an eighth set of channels back to a fourth end. A second winding may include at least a fourth phase electrically isolated from the first three phases. Alternatively, or additionally, there may be a single phase, or any number of electrically isolated phases for a winding, and there may be a single winding or any number of windings A second winding is connected to at least a second inverter, and in non-limiting illustrative embodiments, each winding may be connected to at least its own inverter. Exemplary embodiments of inverters to which windings may connect are illustrated below for exemplary purposes; there may be any number of inverters and corresponding windings, including without limitation six inverters and six corresponding windings. An inverter, for the purposes of this disclosure, is a power electronic device or circuitry that changes direct current (DC) to alternative current (AC). An inverter (also called a power inverter) can be entirely electronic or may be a combination of mechanical effects (such as a rotary apparatus) and electronic circuitry. Alternatively, static inverters do not use moving parts in the conversion process. Inverters do not produce any power itself, rather it converts power produced by a DC power source. Inverters are often used in electrical power applications where high currents and voltages are present; circuits that perform the same function for electronic signals, which usually have very low currents and voltages, are called oscillators. Circuits that perform the opposite function, converting AC to DC, are called rectifiers.

Referring now to FIG. 4, an embodiment of motor 400 is illustrated. Motor 400 may include at least a stator. In an embodiment, stator 404 may include a first magnetic element 408. As used herein, first magnetic element 408 is an element that generates a magnetic field. For example, first magnetic element 408 may include one or more magnets which may be assembled in rows along a structural casing component. Further, first magnetic element 408 may include one or more magnets having magnetic poles oriented in at least a first direction. The magnets may include at least a permanent magnet. Permanent magnets may be composed of, but are not limited to, ceramic, alnico, samarium cobalt, neodymium iron boron materials, any rare earth magnets, and the like. Further, the magnets may include an electromagnet. As used herein, an electromagnet is an electrical component that generates magnetic field via induction; the electromagnet may include a coil of electrically conducting material, through which an electric current flow to generate the magnetic field, also called a field coil of field winding. A coil may be wound around a magnetic core, which may include without limitation an iron core or other magnetic material. The core may include a plurality of steel rings insulated from one another and then laminated together; the steel rings may include slots in which the conducting wire will wrap around to form a coil. First magnetic element 408 may act to produce or generate a magnetic field to cause other magnetic elements to rotate, as described in further detail below. Stator 404 may include a frame to house components including first magnetic element 408, as well as one or more other elements or components as described in further detail below. In an embodiment, a magnetic field may be generated by first magnetic element 408 and can include a variable magnetic field. In embodiments, a variable magnetic field may be achieved by use of an inverter, a controller, or the like. In an embodiment, stator 404 may have an inner and outer cylindrical surface; a plurality of magnetic poles may extend outward from the outer cylindrical surface of the stator. In an embodiment, stator 404 may include an annular stator, wherein the stator is ring-shaped. In an embodiment, stator 404 is incorporated into a DC motor where stator 404 is fixed and functions to supply the magnetic fields where a corresponding rotor, as described in further detail below, rotates. In an embodiment, stator 404 may be incorporated an AC motor where stator 404 is fixed and functions to supply the magnetic fields by radio frequency electric currents through an electromagnet to a corresponding rotor, as described in further detail below, rotates.

With continued reference to FIG. 4, motor 400 may include propulsor 412. In embodiments, propulsor 412 may include an integrated rotor. As used herein, a rotor is a portion of an electric motor that rotates with respect to a stator of the electric motor, such as stator 404. A propulsor, as used herein, is a component or device used to propel a craft by exerting force on a fluid medium, which may include a gaseous medium such as air or a liquid medium such as water. Propulsor 412 may be any device or component that consumes electrical power on demand to propel an aircraft or other vehicle while on ground and/or in flight. Propulsor 412 may include one or more propulsive devices. In an embodiment, propulsor 412 may include a thrust element which may be integrated into the propulsor. A thrust element may include any device or component that converts the mechanical energy of a motor, for instance in the form of rotational motion of a shaft, into thrust in a fluid medium. For example, a thrust element may include without limitation a marine propeller or screw, an impeller, a turbine, a pump-jet, a paddle or paddle-based device, or the like. As another non-limiting example, at least a propulsor may include an eight-bladed pusher propeller, such as an eight-bladed propeller mounted behind the engine to ensure the drive shaft is in compression. Persons skilled in the art, upon reviewing the entirety of this disclosure, will be aware of various devices that may be used as at least a thrust element. As used herein, a propulsive device may include, without limitation, a device using moving or rotating foils, including without limitation one or more rotors, an airscrew or propeller, a set of airscrews or propellers such as contra-rotating propellers, a moving or flapping wing, or the like. In an embodiment, propulsor 412 may include at least a blade. Persons skilled in the art, upon reviewing the entirety of this disclosure, will be aware of various devices that may be used as propulsor 412. In an embodiment, when a propulsor twists and pulls air behind it, it will, at the same time, push the aircraft forward with an equal amount of force. The more air pulled behind the aircraft, the more the aircraft is pushed forward. In an embodiment, thrust element may include a helicopter rotor incorporated into propulsor 412. A helicopter rotor, as used herein, may include one or more blade or wing elements driven in a rotary motion to drive fluid medium in a direction axial to the rotation of the blade or wing element. Its rotation is due to the interaction between the windings and magnetic fields which produces a torque around the rotor's axis. A helicopter rotor may include a plurality of blade or wing elements.

With continued reference to FIG. 4, in an embodiment, propulsor 412 may include hub 416 rotatably mounted to stator 404. Rotatably mounted, as described herein, is functionally secured in a manner to allow rotation. Hub 416 is a structure which allows for the mechanically coupling of components of the integrated rotor assembly. In an embodiment, hub 416 can be mechanically coupled to propellers or blades. In an embodiment, hub 416 may be cylindrical in shape such that it may be mechanically joined to other components of the rotor assembly. Hub 416 may be constructed of any suitable material or combination of materials, including without limitation metal such as aluminum, titanium, steel, or the like, polymer materials or composites, fiberglass, carbon fiber, wood, or any other suitable material. Hub 416 may move in a rotational manner driven by interaction between stator and components in the rotor assembly. Persons skilled in the art, upon reviewing the entirety of this disclosure, will be aware of various structures that may be used as or included as hub 416, as used and described herein.

With continued reference to FIG. 4, in an embodiment, propulsor 412 and/or rotor shaft 436 may include second magnetic element 420, which may include one or more further magnetic elements. Second magnetic element 420 generates a magnetic field designed to interact with first magnetic element 408. Second magnetic element 420 may be designed with a material such that the magnetic poles of at least a second magnetic element are oriented in an opposite direction from first magnetic element 408. In an embodiment, second magnetic element 420 may be affixed to hub 416, rotor shaft 436, or another rotating or stationary electric motor component disclosed herein. Affixed, as described herein, is the attachment, fastening, connection, and the like, of one component to another component. For example, and without limitation, affixed may include bonding the second magnetic element 420 to hub 416, such as through hardware assembly, spot welding, riveting, brazing, soldering, glue, and the like. Second magnetic element 420 may include any magnetic element suitable for use as first magnetic element 408. For instance, and without limitation, second magnetic element may include a permanent magnet and/or an electromagnet. Second magnetic element 420 may include magnetic poles oriented in a second direction opposite, in whole or in part, of the orientation of the poles of first magnetic element 408. In an embodiment, motor 400 may include a motor assembly incorporating stator 404 with a first magnet element and second magnetic element 420. First magnetic element 408 may include magnetic poles oriented in a first direction, a second magnetic element includes a plurality of magnetic poles oriented in the opposite direction than the plurality of magnetic poles in the first magnetic element 408.

With continued reference to FIG. 4, in an embodiment, first magnetic element 408 may be a productive element, defined herein as an element that produces a varying magnetic field. Productive elements may produce magnetic field that may attract and other magnetic elements, possibly including a receptive element. Second magnetic element may be a productive or receptive element. A receptive element may react due to the magnetic field of first magnetic element 408. In an embodiment, first magnetic element 408 may produce a magnetic field according to magnetic poles of first magnetic element 408 oriented in a first direction. Second magnetic element 420 may produce a magnetic field with magnetic poles in the opposite direction of the first magnetic field, which may cause the two magnetic elements to attract one another. Receptive magnetic element may be slightly larger in diameter than the productive element. Interaction of productive and receptive magnetic elements may produce torque and cause the assembly to rotate. Hub 416 and rotor assembly may both be cylindrical in shape where rotor may have a slightly smaller circumference than hub 416 to allow the joining of both structures. Coupling of hub 416 to stator 404 may be accomplished via a surface modification of either the hub 416, the stator 404, or both to form a locking mechanism. Coupling may be accomplished using additional nuts, bolts, and/or other fastening apparatuses. In an embodiment, an integrated rotor assembly as described above may reduce profile drag in forward flight for an electric aircraft. Profile drag may be caused by a number of external forces that the aircraft is subjected to. In an embodiment, incorporating the propulsor 412 into hub 416, may reduce a profile of motor 400 resulting in a reduced profile drag. In an embodiment, the rotor, which may include motor inner magnet carrier 424, motor outer magnet carrier 428, and propulsor 412 may be incorporated into hub 416. In an embodiment, motor inner magnet carrier 424 may rotate in response to a magnetic field. The rotation may cause hub 416 to rotate. This unit may be inserted into motor 400 as one unit. This may enable ease of installation, maintenance, and removal.

With continued reference to FIG. 4, stator 404 may include through-hole 432. Through-hole 432 may provide an opening for a component to be inserted through to aid in attaching propulsor with integrated rotor and rotor shaft to stator. In an embodiment, through-hole 432 may have a round or cylindrical shape and be located at a rotational axis of stator 404, which in an embodiment may be similar to or the same as axis of rotation 212. Hub 416 may be mounted to stator 404 by means of rotor shaft 436 rotatably inserted though through-hole 432. The rotor shaft 436 may be mechanically coupled to stator 404 such that rotor shaft 436 is free to rotate about its centerline axis, which may be effectively parallel and coincident to stator's centerline axis, and further the rotor shaft and stator may include a void of empty space between them, where at least a portion the outer cylindrical surface of the rotor shaft is not physically contacting at least a portion of the inner cylindrical surface of the stator. This void may be filled, in whole or in part, by air, a vacuum, a partial vacuum or other gas or combination of gaseous elements and/or compounds, to name a few. Through-hole 432 may have a diameter that is slightly larger than a diameter of rotor shaft 436 to allow rotor shaft 436 to fit through through-hole 432 to connect stator 404 to hub 416. Rotor shaft 436 may rotate in response to rotation of propulsor 412.

With continued reference to FIG. 4, motor 400 may include a bearing cartridge 440. Bearing cartridge 440 may include a bore. Rotor shaft 436 may be inserted through the bore of bearing cartridge 440. Bearing cartridge 440 may be attached to a structural element of a vehicle. Bearing cartridge 440 functions to support the rotor and to transfer the loads from the motor. Loads may include, without limitation, weight, power, magnetic pull, pitch errors, out of balance situations, and the like. Bearing cartridge 440 may include a bore. Bearing cartridge 440 may include a smooth metal ball or roller that rolls against a smooth inner and outer metal surface. The rollers or balls take the load, allowing the device to spin. a bearing may include, without limitation, a ball bearing, a straight roller bearing, a tapered roller bearing or the like. Bearing cartridge 440 may be subject to a load which may include, without limitation, a radial or a thrust load. Depending on the location of bearing cartridge 440 in the assembly, it may see all of a radial or thrust load or a combination of both. In an embodiment, bearing cartridge 440 may join motor 400 to a structure feature. Bearing cartridge 440 may function to minimize the structural impact from the transfer of bearing loads during flight and/or to increase energy efficiency and power of propulsor. Bearing cartridge 440 may include a shaft and collar arrangement, wherein a shaft affixed into a collar assembly. A bearing element may support the two joined structures by reducing transmission of vibration from such bearings. Roller (rolling-contact) bearings are conventionally used for locating and supporting machine parts such as rotors or rotating shafts. Typically, the rolling elements of a roller bearing are balls or rollers. In general, a roller bearing is a is type of anti-friction bearing; a roller bearing functions to reduce friction allowing free rotation. Also, a roller bearing may act to transfer loads between rotating and stationary members. In an embodiment, bearing cartridge 440 may act to keep propulsor 412 and components intact during flight by allowing motor 400 to rotate freely while resisting loads such as an axial force. In an embodiment, bearing cartridge 440 may include a roller bearing incorporated into the bore. a roller bearing is in contact with rotor shaft 436. Stator 404 may be mechanically coupled to inverter housing. Mechanically coupled may include a mechanical fastening, without limitation, such as nuts, bolts or other fastening device. Mechanically coupled may include welding or casting or the like. Inverter housing may contain a bore which allows insertion by rotor shaft 436 into bearing cartridge 440.

With continued reference to FIG. 4, motor 400 may include a motor assembly incorporating a rotating assembly and a stationary assembly. Hub 416, motor inner magnet carrier 424 and rotor shaft 436 may be incorporated into the rotor assembly of motor 400 which make up rotating parts of electric motor, moving between the stator poles and transmitting the motor power. As one integrated part, the rotor assembly may be inserted and removed in one piece. Stator 404 may be incorporated into the stationary part of the motor assembly. Stator and rotor may combine to form an electric motor. In embodiment, an electric motor may, for instance, incorporate coils of wire, which may be similar to or the same as any of the electrically conductive components in the entirety of this disclosure, which are driven by the magnetic force exerted by a first magnetic field on an electric current. The function of the motor may be to convert electrical energy into mechanical energy. In operation, a wire carrying current may create at least a first magnetic field with magnetic poles in a first orientation which interacts with a second magnetic field with magnetic poles oriented in the opposite direction of the first magnetic pole direction causing a force that may move a rotor in a direction. For example, and without limitation, first magnetic element 408 in motor 400 may include an active magnet. For instance, and without limitation, a second magnetic element may include a passive magnet, a magnet that reacts to a magnetic force generated by first magnetic element 408. In an embodiment, a first magnet positioned around the rotor assembly, may generate magnetic fields to affect the position of the rotor relative to the stator 404. A controller may have an ability to adjust electricity originating from a power supply and, thereby, the magnetic forces generated, to ensure stable rotation of the rotor, independent of the forces induced by the machinery process.

With continued reference to FIG. 4, motor 400 may include impeller 444, which may be used as impeller 720, coupled with the rotor shaft 436. An impeller, as described herein, is a rotor used to increase or decrease the pressure and flow of a fluid, including at least air. Impeller 444 may function to provide cooling to motor 400. Impeller 444 may include varying blade configurations, such as radial blades, non-radial blades, semi-circular blades and airfoil blades. Impeller 444 may further include single and/or double-sided configurations. Impeller 444 is described in further detail below. Additionally, or alternatively, in a non-limiting illustrative example, rotor shaft 436 may be mechanically coupled to cooling vanes. Cooling vanes are used to lower the temperature of a high-velocity mechanical part, like the rotor in an electrical motor. Cooling vanes may employ a plurality of physical principles to cool mechanical parts. Cooling vanes may draw cool air like a fan if mechanically coupled to the rotor at an angle sufficient to create a pressure differential in order to draw cool air from outside the motor housing into the relatively hot inner motor and cool internal mechanical parts by convection. The cooling vanes may alternatively or additionally cool other components disclosed herein with the impeller. Convection cooling in principle, is cooling of a portion of a body by moving a fluid over it, the tendency of heat energy to move from high to low energy areas, like a hot spinning rotor to cool moving air. Additionally, cooling vanes may act as thermodynamic fins. Heat energy may be conducted through the cooling vanes from the hot rotor shaft to the tips of the cooling vanes, thus dissipating heat in a high-speed rotating part. Cooling vanes may be consistent with those disclosed in U.S. patent application Ser. No. 16/910,255 entitled “Integrated Electric Propulsion Assembly” and incorporated herein by reference in its entirety.

Now referring to FIG. 5, electric aircraft 500 may include motor 400 may be mounted on a structural feature of an aircraft. Design of motor 400 may enable it to be installed external to the structural member (such as a boom, nacelle, or fuselage) for easy maintenance access and to minimize accessibility requirements for the structure. This may improve structural efficiency by requiring fewer large holes in the mounting area. This design may include two main holes in the top and bottom of the mounting area to access bearing cartridge. Further, a structural feature may include a component of electric aircraft 500. For example, and without limitation structural feature may be any portion of a vehicle incorporating the motor 400, including any vehicle as described below. As a further non-limiting example, a structural feature may include without limitation a wing, a spar, an outrigger, a fuselage, or any portion thereof; persons skilled in the art, upon reviewing the entirety of this disclosure, will be aware of many possible features that may function as at least a structural feature. At least a structural feature may be constructed of any suitable material or combination of materials, including without limitation metal such as aluminum, titanium, steel, or the like, polymer materials or composites, fiberglass, carbon fiber, wood, or any other suitable material. As a non-limiting example, at least a structural feature may be constructed from additively manufactured polymer material with a carbon fiber exterior; aluminum parts or other elements may be enclosed for structural strength, or for purposes of supporting, for instance, vibration, torque or shear stresses imposed by the propulsor 412. Persons skilled in the art, upon reviewing the entirety of this disclosure, will be aware of various materials, combinations of materials, and/or constructions techniques.

With continued reference to FIG. 5, electric aircraft 500 may include a vertical takeoff and landing aircraft (eVTOL). As used herein, a vertical take-off and landing (eVTOL) aircraft is one that can hover, take off, and land vertically. An eVTOL, as used herein, is an electrically powered aircraft typically using an energy source, of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

With continued reference to FIG. 5, a number of aerodynamic forces may act upon the electric aircraft 500 during flight. Forces acting on electric aircraft 500 during flight may include, without limitation, thrust, the forward force produced by the rotating element of the electric aircraft 500 and acts parallel to the longitudinal axis. Another force acting upon electric aircraft 500 may be, without limitation, drag, which may be defined as a rearward retarding force which is caused by disruption of airflow by any protruding surface of the electric aircraft 500 such as, without limitation, the wing, rotor, and fuselage. Drag may oppose thrust and acts rearward parallel to the relative wind. A further force acting upon electric aircraft 500 may include, without limitation, weight, which may include a combined load of the electric aircraft 500 itself, crew, baggage, and/or fuel. Weight may pull electric aircraft 500 downward due to the force of gravity. An additional force acting on electric aircraft 500 may include, without limitation, lift, which may act to oppose the downward force of weight and may be produced by the dynamic effect of air acting on the airfoil and/or downward thrust from the propulsor 412 of the electric aircraft. Lift generated by the airfoil may depend on speed of airflow, density of air, total area of an airfoil and/or segment thereof, and/or an angle of attack between air and the airfoil. For example, and without limitation, electric aircraft 500 are designed to be as lightweight as possible. Reducing the weight of the aircraft and designing to reduce the number of components is essential to optimize the weight. To save energy, it may be useful to reduce weight of components of electric aircraft 500, including without limitation propulsors and/or propulsion assemblies. In an embodiment, motor 400 may eliminate need for many external structural features that otherwise might be needed to join one component to another component. Motor 400 may also increase energy efficiency by enabling a lower physical propulsor profile, reducing drag and/or wind resistance. This may also increase durability by lessening the extent to which drag and/or wind resistance add to forces acting on electric aircraft 500 and/or propulsors.

With continued reference to FIG. 5, electric aircraft 500 can include motor 400. Motor 400 may include a stator which has a first magnetic generating element generating a first magnetic field. Motor 400 may also include propulsor 412 with an integrated rotor assembly of the motor assembly which may include includes a hub mounted to stator, at least a second magnetic element generating a second magnetic field. First magnetic field and second magnetic field vary with respect to time which generates a magnetic force between both causing the rotor assembly to rotate with respect to the stator.

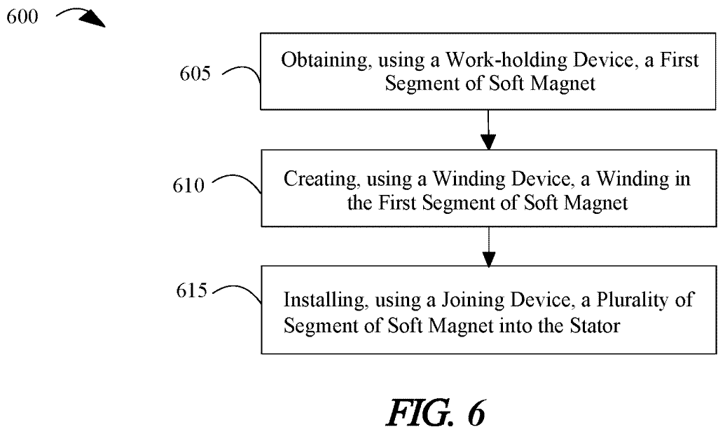

Referring now to FIG. 6, a method 600 for manufacturing a stator with cooling system for an electric aircraft is illustrated. Method 600 includes a step 605, of obtaining, using a work-holding device, a first segment of soft magnet, without limitation. In some embodiments, the first segment of soft magnet may contain a plurality of soft magnet, wherein each soft magnet of the plurality of soft magnet further includes an inner soft magnet end with a first width, and an outer soft magnet end with a second width, and the first width is different than the second width. Additionally, the step 605 of obtaining the first segment of soft magnet may include insulating the soft magnet body (the area between the inner soft magnet end and the outer tooth end) in the first segment of soft magnet using insulation material. Additional disclosure related to a method for manufacturing a stator may be found in U.S. patent application Ser. No. 17/892,816 and entitled “METHODS AND APPARATUS FOR MANUFACTURING A STATOR FOR AN ELECTRIC AIRCRAFT MOTOR” the entirety of which is incorporated by reference herein in its entirety.

With continued reference to FIG. 6, method 600 includes a step 610 of creating, using at least a winding device, a winding in the first segment of soft magnet. The step 610 of creating the winding further include acquiring an electrically conductive material and winding the electrically conductive material upon each soft magnet of the plurality of soft magnet thereby creating a winding for each soft magnet. In some embodiments, the electrically conductive material may include a hollow conductor. In some embodiments, the hollow conductor may contain a channel containing a cooling media, active as a passive heat sink. In some embodiments, the cooling media may include a phase change material. In some embodiment, winding the electrically conductive material may include winding the electrically conductive material about a winding axis that is perpendicular to the axis of rotation of work-holding device. In some embodiments, winding the electrically conductive material may include a plurality of multiphase windings. In some embodiments, winding the continuous conductor may further include attaching the continuous conductor to the soft magnet using heat and/or chemical resistant cord. Additional disclosure related to a method for manufacturing a stator may be found in U.S. patent application Ser. No. 17/892,816 and entitled “METHODS AND APPARATUS FOR MANUFACTURING A STATOR FOR AN ELECTRIC AIRCRAFT MOTOR” the entirety of which is incorporated by reference herein in its entirety.

With continued reference to FIG. 6, method 600 includes a step 615 of installing, using at least an installation device, a plurality of segment of soft magnet into the stator. In some embodiments, the installation device may include a plurality of pins. In some embodiments, installing the plurality of segment of soft magnet into the stator further include applying to the stator a polyester-based varnish and hardening the polyester-based varnish on the stator. Additional disclosure related to a method for manufacturing a stator may be found in U.S. patent application Ser. No. 17/892,816 and entitled “METHODS AND APPARATUS FOR MANUFACTURING A STATOR FOR AN ELECTRIC AIRCRAFT MOTOR” the entirety of which is incorporated by reference herein in its entirety.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve embodiments according to this disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An electric aircraft, comprising:
a propulsor system configured to generate thrust in a first direction during a vertical takeoff, wherein the propulsor system includes a motor configured to generate movement of the propulsor system during the vertical takeoff, the motor including:
a stator configured as a passive heatsink for the motor, the stator including:
a winding formed from a hermetically sealed hollow conductor comprising a coolant, wherein the coolant absorbs heat energy generated by the motor during the vertical takeoff based on a phase change of the coolant from a first phase to a second phase.

2. The electric aircraft according to claim 1, wherein:
the phase change is a first phase change; and
the coolant dissipates the heat energy after the vertical takeoff based on a second phase change of the coolant from the second phase to the first phase.

3. The electric aircraft according to claim 1, wherein the coolant is a hydrated salt type phase change material.

4. The electric aircraft according to claim 1, wherein the coolant is an organic type phase change material.

5. The electric aircraft according to claim 1, wherein the first phase is a solid and the second phase is a liquid.

6. The electric aircraft according to claim 1, wherein the coolant is a phase change material that has a mass selected based on an operation time of the motor during the vertical takeoff.

7. The electric aircraft according to claim 1, wherein the coolant is a phase change material that has a mass selected based on a power of the motor consumed during the vertical takeoff.

8. The electric aircraft according to claim 1, wherein the coolant is a phase change material that has a transition temperature which is equal to or less than an operation temperature of the motor during the vertical takeoff.

9. The electric aircraft according to claim 1, wherein the propulsor system is a vertical propulsor system and wherein the passive heatsink is further configured to:
absorb the heat energy generated by the motor during a vertical landing of the electric aircraft.

10. The electric aircraft according to claim 1, wherein the propulsor system is a vertical propulsor system and the thrust is a first thrust in a vertical direction and wherein the electric aircraft further comprises:
a forward propulsor system configured to generate a second thrust in a horizontal direction after the vertical takeoff and during an airplane-style flight mode of the electric aircraft.

11. The electric aircraft according to claim 10, wherein:
the vertical propulsor system is configured to generate less thrust after the vertical takeoff and during the airplane-style flight mode of the electric aircraft; and
the coolant dissipates the heat energy after the vertical takeoff during the airplane-style flight mode of the electric aircraft.

12. An electric vertical takeoff and landing aircraft comprising:
an electric motor having at least one stator winding configured to conduct a current to rotate a rotor during a vertical takeoff period, the rotor coupled to a propulsor via a rotor shaft, the at least one stator winding including:
a hollow conductor defining a channel, the channel being sealed; and
a coolant being disposed within the channel of the hollow conductor, the coolant configured to absorb heat energy generated by the current during the vertical takeoff period.

13. The electric vertical takeoff and landing aircraft according to claim 12, wherein the propulsor is a vertical propulsor configured to propel the electric vertical takeoff and landing aircraft in an upward direction during the vertical takeoff period.

14. The electric vertical takeoff and landing aircraft according to claim 13, wherein the electric motor further includes an impeller coupled to the rotor shaft the impeller configure to further cool the electric motor during a vertical takeoff.

15. The electric vertical takeoff and landing aircraft according to claim 12, wherein:
the coolant absorbs the heat energy when the coolant undergoes a phase transition from a solid state to a liquid state; and
the coolant releases the heat energy when the coolant undergoes the phase transition from the liquid state to the solid state.

16. The electric vertical takeoff and landing aircraft according to claim 15, wherein the coolant releases the heat energy after the vertical takeoff period when the electric vertical takeoff and landing aircraft is in an airplane-style flight.

17. The electric vertical takeoff and landing aircraft according to claim 15, wherein the coolant has a mass based on an operation time of the electric motor during the vertical takeoff period.

18. The electric vertical takeoff and landing aircraft according to claim 15, the at least one stator winding is configured to conduct the current to rotate the rotor during a vertical landing period and the coolant configured to absorb heat energy generated by the current during the vertical landing period.

19. A method for cooling an electric motor of an electric aircraft, the method comprising:
providing a current to at least one stator winding of the electric motor to rotate a propulsor during a vertical takeoff period, the at least one stator winding including a hollow conductor defining a sealed channel;
heating, by the current, a coolant sealed within the hollow conductor to cause a phase transition of the coolant; and
absorbing heat energy during the vertical takeoff period based on the phase transition of the coolant.

20. The method for cooling the electric motor of the electric aircraft according to claim 19 further comprising:
releasing the heat energy after the vertical takeoff period when the electric aircraft is in an airplane-style flight based on a reversed phase transition of the coolant.
